(19) United States
(12) Patent Application Publication
(10) Pub. No.: US 2009/0026288 A1
(43) Pub. Date: Jan. 29, 2009

(54) Double Atomization Paint Spray Gun

(76) Inventor: Hsien-Chao Shih, Fuhsing Hsiang (TW)

Correspondence Address: RABIN & BERDO, P.C., Suite 500, 1101 14th Street, N.W., Washington, DC, 20005, US

(21) Appl. No.: 11/782,709

(22) Filed: Jul. 25, 2007

(51) Int. Cl. B05B 1/28

(52) U.S. Cl. 239/296

(57) ABSTRACT

A double atomization paint spray gun, the nozzle bushing is additionally installed at the spray gun spray nozzle air emission annular groove and, furthermore, the base section has disposed a plurality of air ducts. When the nozzle bushing is placed over the spray nozzle, several air output guide channels are formed between the two components. At the same time, when the spray cover is fastened to the muzzle aspect of the spray gun body, another air output guide channel is formed between the spray cover and the nozzle bushing, the special capacity of which causes the paint to undergo double atomization. As such, during the large area atomization of paint, the special capacity enables atomization to occur more evenly and, furthermore, causes the atomized particles to become considerably more diminutive, thereby greatly raising atomized paint quality.

### BACKGROUND OF THE INVENTION

1) Field of the Invention

The invention herein relates to a double atomization paint spray gun, in which a nozzle bushing is additionally disposed at the spray gun nozzle such that when the spray gun has the spray cover installed for utilization, in addition to said nozzle bushing and spray cover providing for the double atomization function, this enables the sprayed particles to become more diminutive and, furthermore, more even, resulting in the achievement of an optimally atomized spray application pattern, which thereby ensures significant industrial practical value and utility.

2) Description of the Prior Art

Conventional paint spray guns, in order to achieve an atomized spray capability, referring to FIG. 1 and FIG. 2, typically utilize an additionally fabricated spray cover 20 that is fastened onto the outer section of the spray gun 10 spray nozzle 11, the air outlet perforations 13 of the spray nozzle 11 air emission annular groove 12 in alignment with the air jet hole 21 correspondingly disposed in the spray cover 20 enabling the utilization of the air delivered to produce a siphon effect that draws and sprays the paint outward and also results in its atomization, air is also delivered through angled spray guide passages 23 disposed in the extended wing tabs 22 of the spray cover 20, the special capacity of which enables control over paint spray shape and area of coverage; in other words, the prior art paint spray gun, when utilized, must first be fitted with the spray cover 20 before spray paint and atomization capability is attained and, furthermore, in this type of spray gun, during spray atomization, since the process only involves the air jet hole 21 of the spray cover 20 that is capable of generating a single instance of atomization, therefore, the sprayed particles are coarser and, furthermore, more uneven, thereby latently limiting spray painting quality, which necessitates finding a means of solution.

### SUMMARY OF THE INVENTION

In view of the shortcomings of prior art paint spray guns, the structural design of which remains largely unperfected, the inventor of the invention herein conducted research to effect improvements which, based on many years of experience and technical expertise gained while engaged in the relevant fields, culminated in the innovative development of the double atomization paint spray gun of the invention herein, the primary objective achieved through the design of the structural arrangement, which employs an additionally disposed nozzle bushing, such that when it and the spray cover are collocated for utilization, this not only causes the sprayed particles to become considerably more diminutive but, at the same time, causes spraying to occur more evenly, thereby effectively increasing spray painting quality.

To achieve the disclosed objectives, in the structural design of the invention herein, the nozzle bushing additionally installed at the air emission annular groove of the spray gun spray nozzle is such that the base section of the nozzle bushing is slightly smaller than the spray nozzle air emission annular groove and, furthermore, the base section has disposed a plurality of air ducts, and when the nozzle bushing is placed over the spray nozzle, several air output guide channels are formed between the two components and, at the same time, when the spray cover is fastened to the muzzle aspect of said spray gun body, another air output guide channel is formed between the spray cover and the nozzle bushing, the special capacity of which causes the paint to undergo double atomization; as such, during the large area atomization of paint, the special capacity enables atomization to occur more evenly and, furthermore, causes the atomized particles to become considerably more diminutive, thereby greatly raising atomized paint quality.

To enable a further understanding of the structural arrangement of the invention herein, as well as the technological means and functional aspects thereof, the brief description of the drawings below are followed by the detailed description of the preferred embodiments.

### BRIEF DESCRIPTION OF THE DRAWINGS

FIG. 1 is an isometric drawing of the prior art paint spray gun.

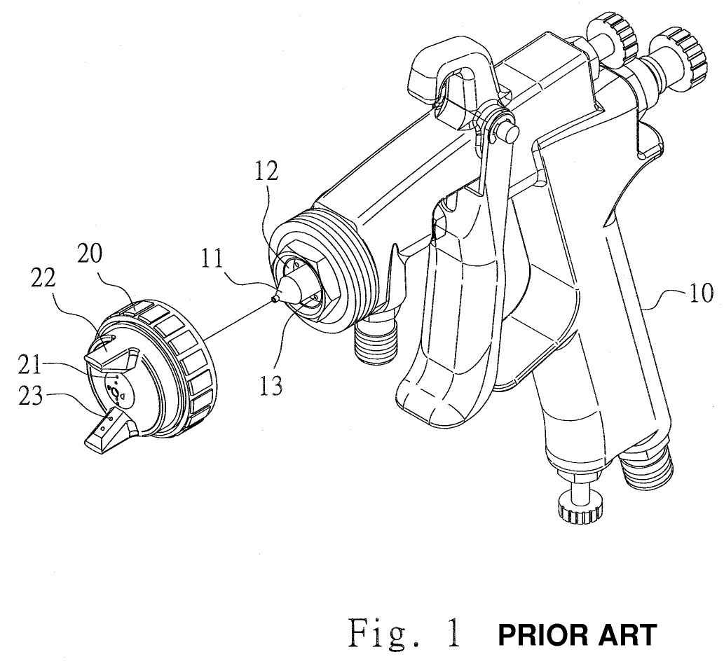

FIG. 2 is an orthographic and partial cross-sectional drawing of the prior art paint spray gun.

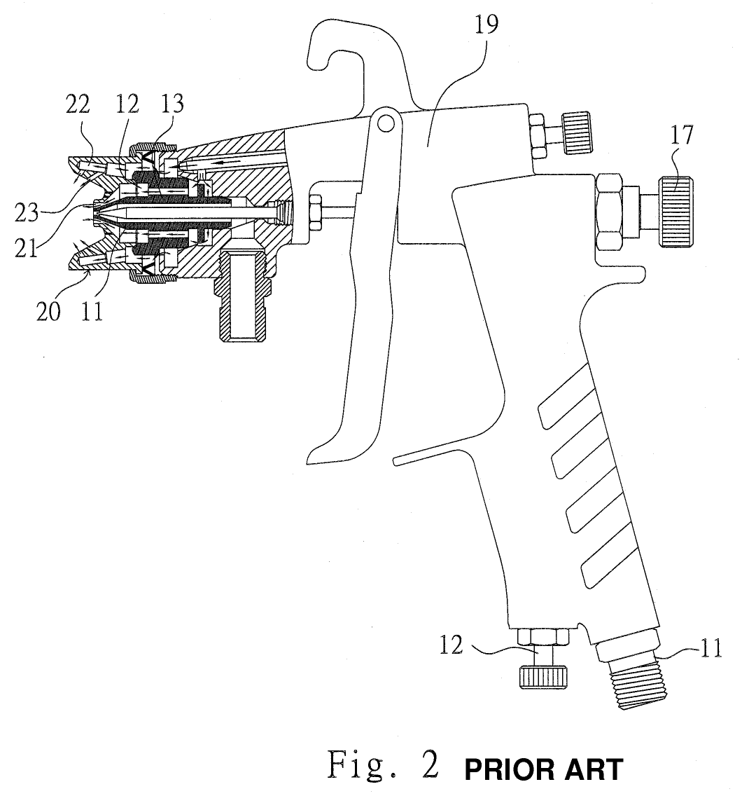

FIG. 3 is an exploded drawing of the preferred embodiment of the invention herein.

FIG. 4 is an orthographic and partial cross-sectional drawing of the preferred embodiment of the invention herein.

FIG. 5 is a cross-sectional drawing of the preferred embodiment of the invention herein when the nozzle bushing and the spray cover are assembled.

### DETAILED DESCRIPTION OF THE PREFERRED EMBODIMENTS

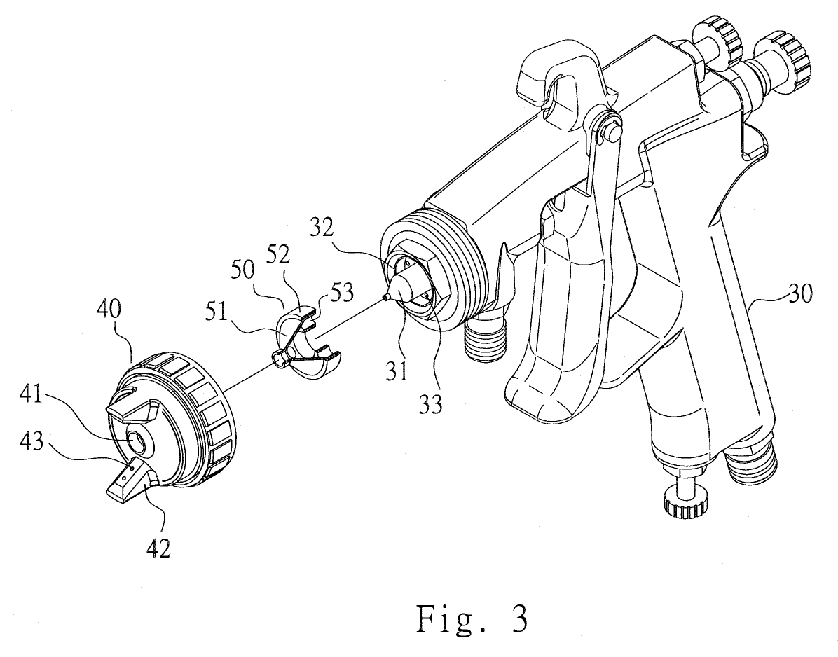

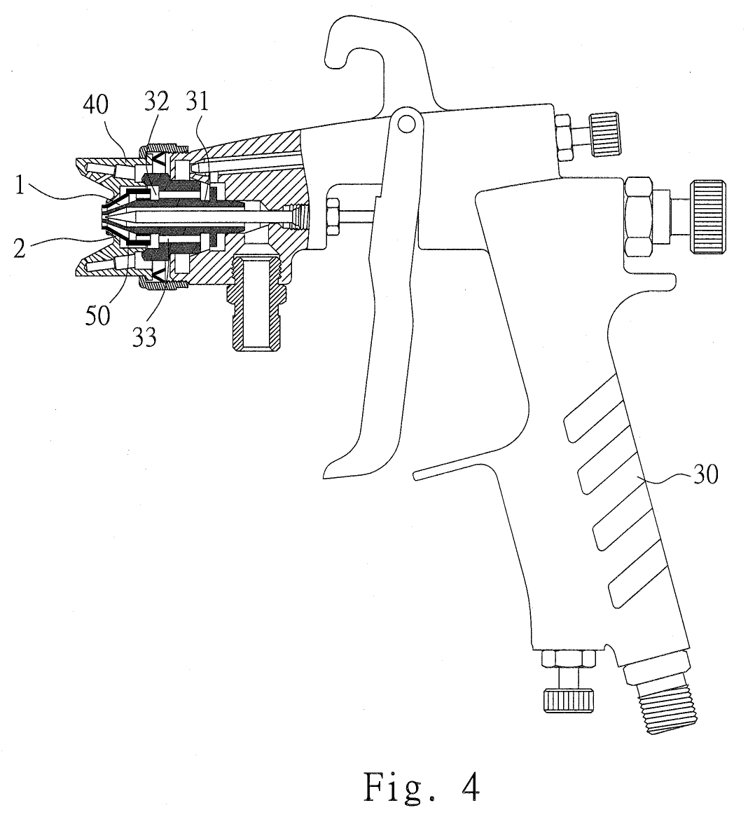

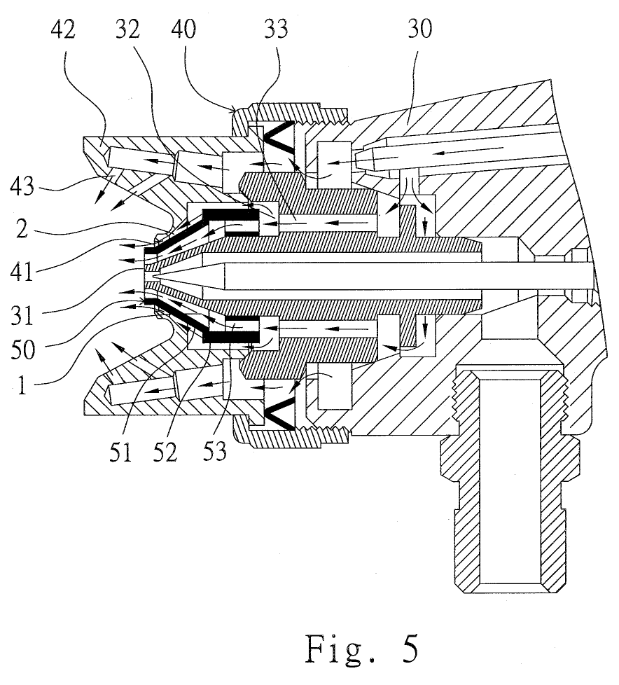

Referring to FIG. 3, FIG. 4, and FIG. 5, the drawings depicting the preferred embodiments of the invention herein, the structural design of the present invention still follows the basic functional structure of existent paint spray guns in that a spray nozzle 31 is fabricated at the muzzle aspect of the spray gun body 30, an air emission annular groove 32 is disposed around the spray nozzle 31 base section, a certain quantity of air outlet perforations 33 are arrayed along the air emission annular groove 32, and a spray cover 40 is fastened onto threads died along the outer circumference of the air emission annular groove 32; utilizing the air outlet perforations 33 of said spray nozzle 31 air emission annular groove 32 in conjunction with the spray cover 40 produces a siphon effect that causes a drawn flow of air that sprays the paint outward, the process also effectively atomizing the paint, the varying of the air vented through the angled spray guide passages 43 disposed in the extended wing tabs 42 of the spray cover 40 enabling the adjustment of the spray shape and the area of coverage, and having such an arrangement, this type of paint spray gun possesses the basic functional structure for atomized spraying; to achieve the double atomization capability of the paint spray gun, the invention herein has a nozzle bushing 50 that is additionally disposed over the outer extent of the spray gun body 30 spray nozzle 31, said nozzle bushing 50 has a profile congruent with that of the spray nozzle 31 but its inner diameter is slightly larger along the conical sleeve section 51 at the spray nozzle 31 outer diameter, the base section 52 at the rear end of the sleeve section 51 formed such that it is smaller than the spray nozzle 31 air emission annular groove 32 and, furthermore, the interior edge of the base section 52 contacts the spray nozzle 31, and said nozzle bushing 50 base section 52 has prefabricated through its sleeve section 51 a plurality of air ducts 53; as such, when the nozzle bushing 50 is placed over the spray nozzle 31, several air output guide channels 1 are formed between the two components, and at the muzzle aspect of said spray gun body 30 the spray cover 40 is fastened to enclose the nozzle bushing 50 and the spray nozzle 31, the inner diameter of said spray cover 40 slightly larger to accommodate the profile of the nozzle bushing 50, and disposed at the spray cover 40 center section is a through-hole 41 that is slightly larger than the anterior aspect of the nozzle bushing 50 sleeve section 51, enabling the formation of an air output guide channel 2 between the spray cover 40 and the nozzle bushing 50 which, in combination with the angled spray guide passages 43 disposed inside the extended wing tabs 42 of the spray cover 40, as well as the coordinative utilization of said spray cover 40 and nozzle bushing 50, constitutes the double atomization structure of the paint spray gun invention herein.

Given the component design of the disclosed structure, when the nozzle bushing 50 and the spray cover 40 are collocated for utilization, air flow is discharged through the spray nozzle 31 and the air output guide channels 1 between the spray nozzle 3 and the nozzle bushing 50, as well as through the air output guide channel 2 between the nozzle bushing 50 and the spray cover 40 and, at the same time, a portion of the air flow is discharged as well through the angled spray guide passages 43 of the spray cover 40 extended wing tabs 42, the air output guide channels 1 and 2 between said spray nozzle 31 and nozzle bushing 50 and also between the nozzle bushing 50 and the spray cover 40 utilized to deliver air pass the spray nozzle 31 to spray paint that undergoes double atomization, the air discharged from the extended wing tabs 42 angled spray guide passages 43 controlling the paint spray atomization shape and area of coverage, and thereby achieving the paint double atomization spray capability of the invention herein, with the double atomization process causing the atomization of the paint into particles that are much more diminutive, while also enabling the more even application of atomized paint onto large surface areas, and as a result effectively increasing its spray painting quality to thereby attain utility which is superior to that of the prior art structure.

As such, in terms of the structural design of the paint spray gun invention herein, the utilization of one nozzle bushing 50 additionally disposed between the spray gun spray cover 40 and spray nozzle 31 enables, when the installed spray cover 40 is used, in addition to the formation of the air output guide channels 1 between the nozzle bushing 50 and the spray nozzle 31 another air output guide channel 2 formed between the spray cover 40 and the nozzle bushing 50, the special capacity of which causes the paint to undergo double atomization such that during the large area atomization of paint, the special capacity enables atomization to occur more evenly and, furthermore, causes the atomized particles to become considerably more diminutive, thereby greatly raising its atomized paint quality and effectively solving the numerous shortcomings faced by existent paint spray guns, while also achieving exceptional industrial practical value and utility.

In summation of the foregoing section, since the double atomization paint spray gun of the invention herein, through the improved design of its gun structure, utilizes at the spray gun nozzle 31 an additionally disposed the one nozzle bushing 50 such that when its spray gun has the spray cover 40 installed for utilization, in addition to said nozzle bushing 50 and spray cover 40 providing for the double atomization function, this enables the sprayed particles to become more diminutive and, furthermore, more even, resulting in the achievement of an optimally atomized spray application pattern, which thereby ensures significant industrial practical value and utility as well as an excellent and advanced original design, the present invention is lawfully submitted in application for the commensurate patent rights.

What is claimed is:

1. A double atomization paint spray gun, wherein a spray nozzle is fabricated at the muzzle aspect of the spray gun body, an air emission annular groove is disposed around the spray nozzle base section, a certain quantity of air outlet perforations are arrayed along said air emission annular groove and a spray cover is fastened onto threads died along the outer diameter of said air emission annular groove; utilizing said air outlet perforations of said spray nozzle air emission annular groove in conjunction with the spray cover to produce a siphon effect that causes a drawn flow of air that sprays the paint outward, the process also effectively atomizing the paint; the varying of the air vented through angled spray guide passages disposed in the extended wing tabs of the spray cover enabling the adjustment of spray shape and area of coverage, and having such an arrangement, this type of paint spray gun possesses the basic functional structure for atomized spraying, the unique features of which includes:
said paint spray gun has a nozzle bushing additionally disposed between the spray nozzle and the spray cover, said nozzle bushing has a profile congruent with that of the spray nozzle but its inner diameter is slightly larger along the conical sleeve section at the spray nozzle outer diameter, the base section at the rear end of said sleeve section formed such that it is smaller than the spray nozzle air emission annular groove and, furthermore, the interior edge of the base section contacts said spray nozzle, and the nozzle bushing base section has prefabricated through the sleeve section a plurality of air ducts; as such, when the nozzle bushing is placed over the spray nozzle, several air output guide channels are formed between the two said components and, at the same time, when the spray cover is fastened to the muzzle aspect of said spray gun body to enclose said nozzle bushing and said spray nozzle, another air output guide channel is formed between the spray cover and the nozzle bushing; the coordinative utilization of the spray cover and the nozzle bushing, the special capacity of which causes the paint to undergo double atomization enabling the paint to be atomized into particles that are more diminutive, while also enabling the atomized paint to be more even, thereby effectively increasing spray painting quality.

2. A double atomization paint spray gun as claimed in claim 1, wherein the spray cover has an inner diameter that is slightly larger to accommodate the profile of the nozzle bushing and disposed at the spray cover center section is a through-hole that is slightly larger than the anterior aspect of the nozzle bushing sleeve section, enabling the formation of the other air output guide channel between the spray cover and the nozzle bushing.
